(19) United States
(12) Patent Application Publication
(10) Pub. No.: US 2001/0047422 A1
(43) Pub. Date: Nov. 29, 2001

(54) System and method for using benchmarking to account for variations in client capabilities in the distribution of a media presentation

(76) Inventors: Brennan J. McTernan, Fanwood, NJ (US); Adam Nemitoff, Ridgewood, NJ (US); Altay Murat, Richmond Hill, NY (US); Vishal Bangia, Jersey City, NJ (US)

Correspondence Address: Brown Raysman Millstein, Felder & Steiner LLP, 900 3rd Ave., New York, NY, 10022-4728, US

(21) Appl. No.: 09/767,603

(22) Filed: Jan. 22, 2001

Related U.S. Application Data
(60) Provisional application No. 60/177,397, filed on Jan. 21, 2000.
(60) Provisional application No. 60/177,394, filed on Jan. 21, 2000.
(60) Provisional application No. 60/177,396, filed on Jan. 21, 2000.
(60) Provisional application No. 60/177,395, filed on Jan. 21, 2000.
(60) Provisional application No. 60/177,398, filed on Jan. 21, 2000.
(60) Provisional application No. 60/177,399, filed on Jan. 21, 2000.
(60) Provisional application No. 60/182,434, filed on Feb. 15, 2000.
(60) Provisional application No. 60/204,386, filed on May 15, 2000.

(51) Int. Cl. G06F 15/16

(52) U.S. Cl. 709/231; 709/219

(57) ABSTRACT

Systems and methods are presented that allow the efficient distribution of rich media to clients by maximizing the use of available bandwidth and client processing capabilities. A rich media presentation is divided into discrete components, and a producer of the presentation specifies how a presentation is to be assembled and where resources needed for the presentation are to be found. This information is packaged into a data structure and sent to clients. Clients use this data structure to retrieve the necessary resources for the presentation. Producers are able to prioritize the particular resources that form part of the ultimate presentation according to their importance in the presentation, and clients can retrieve the resources most suitable for their capabilities, including processing power, graphics production speed, and bandwidth. A benchmarker routine running on the client helps identify these capabilities just before retrieval of the presentation components, to more closely assess the conditions under which the client will retrieve, assemble and present the desired show.

Applicant(s) hereby claims the benefit of the following provisional patent applications:

provisional patent application serial no. 60/177,397, titled “VIRTUAL SET ON THE INTERNET,” filed Jan. 21, 2000, attorney docket no. 38903-007;

provisional patent application serial no. 60/177,394, titled “MEDIA ENGINE,” filed Jan. 21, 2000, attorney docket no. 38903-004;

provisional patent application serial no. 60/177,396, titled “TAP METHOD OF ENCODING AND DECODING INTERNET TRANSMISSIONS,” filed Jan. 21, 2000, attorney docket no. 38903-006;

provisional patent application serial no. 60/177,395, titled “SCALABILITY OF A MEDIA ENGINE,” filed Jan. 21, 2000, attorney docket no. 38903-005;

provisional patent application serial no. 60/177,398, titled “CONNECTION MANAGEMENT,” filed Jan. 21, 2000, attorney docket no. 38903-008;

provisional patent application serial no. 60/177,399, titled “LOOPING DATA RETRIEVAL MECHANISM,” filed Jan. 21, 2000, attorney docket no. 38903-009;

provisional patent application serial no. 60/182,434, titled “MOTION CAPTURE ACROSS THE INTERNET,” filed Feb. 15, 2000, attorney docket no. 38903-010; and

provisional patent application serial no. 60/204,386, titled “AUTOMATIC IPSEC TUNNEL ADMINISTRATION,” filed May 10, 2000, attorney docket no. 38903-014.

Each of the above listed applications is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### RELATED APPLICATIONS

This application is related to the following commonly owned patent applications, filed concurrently herewith, each of which applications is hereby incorporated by reference herein in its entirety:

application serial no.______, titled “METHOD AND SYSTEM FOR DISTRIBUTING VIDEO USING A VIRTUAL SET,” attorney docket no. 4700/2;

application serial no.______, titled “SYSTEM AND METHOD FOR ACCOUNTING FOR VARIATIONS IN CLIENT CAPABILITIES IN THE DISTRIBUTION OF A MEDIA PRESENTATION,” attorney docket no. 4700/4;

application serial no.______, titled “SYSTEM AND METHOD FOR MANAGING CONNECTIONS TO SERVERS DELIVERING MULTIMEDIA CONTENT,” attorney docket no. 4700/6; and

application serial no.______, titled “SYSTEM AND METHOD FOR RECEIVING PACKET DATA MULTICAST IN SEQUENTIAL LOOPING FASHION,” attorney docket no. 4700/7.

### BACKGROUND OF THE INVENTION

The invention disclosed herein relates generally to techniques for distributing multimedia content across computer networks. More particularly, the present invention relates to improved systems and methods for efficiently dividing processing between servers distributing content and clients playing back the received content, thereby allowing a richer experience and maximizing processing power of both clients and servers.

Over the past decade, processing power available to both producers and consumers of multimedia content has increased exponentially. Approximately a decade ago, the transient and persistent memory available to personal computers was measured in kilobytes (8 bits=1 byte, 1024 bytes=1 kilobyte) and processing speed was typically in the range of 2 to 16 megahertz. Due to the high cost of personal computers, many institutions opted to utilize “dumb” terminals, which lack all but the most rudimentary processing power, connected to large and prohibitively expensive mainframe computers that “simultaneously” distributed the use of their processing cycles with multiple clients.

Today, transient and persistent memory is typically measured in megabytes and gigabytes, respectively (1,048,576 bytes=1 megabyte, 1,073,741,824 bytes=1 gigabyte). Processor speeds have similarly increased, modern processors based on the x86 instruction set are available at speeds up to 1.5 gigahertz (approximately 1000 megahertz=1 gigahertz). Indeed, processing and storage capacity have increased to the point where personal computers, configured with minimal hardware and software modifications, fulfill roles such as data warehousing, serving, and transformation, tasks that in the past were typically reserved for mainframe computers. Perhaps most importantly, as the power of personal computers has increased, the average cost of ownership has fallen dramatically, providing significant computing power to average consumers.

The past decade has also seen the widespread proliferation of computer networks. With the development of the Internet in the late 1960's followed by a series of inventions in the fields of networking hardware and software, the foundation was set for the rise of networked and distributed computing. Once personal computing power advanced to the point where relatively high speed data communication became available from the desktop, a domino effect was set in motion whereby consumers demanded increased network services, which in turn spurred the need for more powerful personal computing devices. This also stimulated the industry for Internet Service providers or ISPs, which provide network services to consumers.

Computer networks transfer data according to a variety of protocols, such as UDP (User Datagram Protocol) and TCP (Transport Control Protocol). According to the UDP protocol, the sending computer collects data into an array of memory referred to as a packet. IP address and port information is added to the head of the packet. The address is a numeric identifier that uniquely identifies a computer that is the intended recipient of the packet. A port is a numeric identifier that uniquely identifies a communications connection on the recipient device.

Once the data packet is addressed, it is transmitted from the sending device across a network via a hardware network adapter, where intermediary computers (e.g., routers) relay the packet to the appropriate port on the device with the appropriate unique IP address. When data is transmitted according to the UDP protocol, however, no attempt is made to inform the sender that the data has successfully arrived at the destination device. Moreover, there is neither feedback from the recipient regarding the quality of the transmission nor any guarantee that subsequent data sent out sequentially by the transmitting device will be received in the same sequence by the recipient.

According to the Transmission Control Protocol, or TCP, data is sent using UDP packets, but there is an underlying “handshake” between sender and recipient that ensures a suitable communications connection is available. Furthermore, additional data is added to each packet identifying its order in an overall transmission. After each packet is received, the receiving device transmits acknowledgment of the receipt to the sending device. This allows the sender to verify that each packet of data sent has been received, in the order it was sent, to the receiving device. Both the UDP and TCP protocols have their uses. For most purposes, the use of one protocol over the other is determined by the temporal nature of the data. Data can be viewed as being divided into two types, transient or persistent, based on the amount of time that the data is useful.

Transient data is data that is useful for relatively short periods of time. For example, a television transmits a video signal consisting of 30 frames of imagery each second. Thus, each frame is useful for 1/30^{th} of a second. For most applications, the loss of one frame would not diminish the utility of the overall stream of images. Persistent data, by contrast, is useful for much longer periods of time and must typically be transmitted completely and without errors. For example, a downloaded record of a bank transaction is a permanent change in the status of the account and is necessary to compute the overall account balance. Loosing a bank transaction or receiving a record of a transaction containing errors would have harmful side effects, such as inaccurately calculating the total balance of the account.

UDP is useful for the transmission of transient data, where the sender does not need to be delayed verifying the receipt of each packet of data. In the above example, a television broadcaster would incur an enormous amount of overhead if it were required to verify that each frame of video transmitted has been successfully received by each of the millions of televisions tuned into the signal. Indeed, it is inconsequential to the individual television viewer that one or even a handful of frames have been dropped out of an entire transmission. TCP, conversely, is useful for the transmission of persistent data where the failure to receive every packet transmitted is of great consequence.

One of the reasons that the Internet is a successful medium for transmitting data is because the storage of information regarding identity and location of devices connected to it is decentralized. Knowledge regarding where a device resides on a particular part of the network is distributed over a plurality of sources across the world. A connection between to remotely located devices can traverse a variety of paths such that if one path becomes unavailable, another route is utilized.

The most simplistic path is between two devices located within a common Local Area Network, or LAN. Because these devices are located on a common network, they are said to reside in the same subnet. Each network on the Internet is uniquely identified with a numeric address. Each device within a network, in turn, is identified by an IP address that is comprised of a subnet address coupled with a unique device ID. According to version four of this standard (“IPv4”) an IP address is a 32-bit number that is represented by four “dot” separated values in the range from 0 through 255, e.g., 123.32.65.72. Each device is further configured with a subnet mask. The mask determines which bits of a device's IP address represent the subnet and which represent the device's ID. For example, a device with an IP address of 123.32.65.72 and a subnet mask of 255.255.255.0 has a subnet address of 123.32.65 and an ID of 72.

Each packet of data sent by a device, whether it is formatted according to the UDP or TCP protocols, has a header data field. The header is an array of bytes at the beginning of a packet that describe the data's destination, its origin, its size, etc. When a sender and recipient are both located within the same subnet, the recipient device's network hardware examines network traffic for packets tagged with its address. When a packet addressed to the recipient is identified, the network hardware will pass the received data off to the operating system's network services software for processing.

When a sender and recipient are located in different subnets, data is relayed from the originating subnet to the destination subnet primarily through the use of routers. While other physical transport methodologies are available, e.g., circuit switched transmission systems such as ATM (Asynchronous Transfer Mode), the majority of computer networks utilize packet switched hardware such as routers. A router is a device that interconnects two networks and contains multiple network hardware connections. Each network connection is associated with, and provides a connection to, a distinct subnet.

Two tasks are performed when a packet, destined for a subnet that is different from the subnet it is currently in, reaches a router within the current subnet. First, the router will examine the subnets that it is connected to via its network hardware. If the router is connected to the packet's destination subnet, it forwards the packet to the router in the appropriate subnet. If the router is not directly connected to the packet's destination subnet, it will query other routers available on its existing connections to determine if any of them are directly connected to the destination subnet. When a router directly connected to the destination subnet is discovered, the packet will be forwarded to it. Where a router connected to the destination subnet is not found, however, the router will propagate the packet to a top level router that is strategically placed to allow access, either directly or through other top level routers, to the entire Internet. These top level routers are currently maintained by a registration authority under government oversight.

The transmission method described above is referred to as the unicast method of transmission, whereby a sender establishes a unique connection with each recipient. By utilizing a unicast model, the specific address of the receiving machine is placed in the packet header. Routers detect this address and forward the packet so that it ultimately reaches its intended recipient. This method, however, is not the most efficient means for distributing information simultaneously to multiple recipients. The transmission method that best facilitates broadcasting to many recipients simultaneously is multicasting.

Multicasting relies on the use of specialized routers referred to as multicast routers. These routers look only for data packets addressed to devices in the range of 224.0.0.0 through 239.255.255.255. This address range has been specifically set aside for the purpose of facilitating multicast transmissions. Multicast routers retain an index of devices that wish to receive packets addressed to ports in this address range. Recipients wishing to receive multicast packets “subscribe” to a specific IP address and port within the multicast address space. The multicast routers respond to the subscription request and proceed to forward packets destined to the particular multicast address to clients who have subscribed to receive them.

Under the multicast model, the sender transmits packets to a single address, as opposed to the unicast model where the data is transmitted individually to each subscribing recipient. The multicast routers handle replication and distribution of packets to each subscribing client. The multicast model, like the broadcast model, can be conceptually viewed as a “one-to-many” connection and, therefore, must use the UDP protocol. UDP must be utilized because the TCP protocol requires a dialog between the sender and receiver that is not present in a multicast environment.

Clearly, there have been drastic improvements in the computer technology available to consumers of content and in the delivery systems for distributing such content. There have also been drastic improvements in bandwidth available for transmission of video and other multimedia, such as through the use of broadband systems such as digital subscriber lines and cable systems employing cable modems.

However, such improvements have not been properly leveraged to improve the quality and speed of video distribution. For example, existing multimedia distribution systems over the Internet offer the content to all or to classes of clients on the same basis, much as is done in traditional analog systems such as television broadcasting. As a result, these systems fail to take account of the wide variability in processing, storage and other technical capabilities among personal computers.

There is thus a need for a system and method that takes account of such client variability, and that furthermore distributes responsibilities for video distribution and presentation among various components in a computer network to more effectively and efficiently leverage the capabilities of each part of the network and improve overall performance.

### BRIEF SUMMARY OF THE INVENTION

It is an object of the present invention to solve the problems described above relating to existing content delivery systems.

It is another object of the present invention to alter the traditional model of distribution of video and other multimedia content to take advantage of each particular client's capabilities.

It is another object of the present invention to make the distribution of video and other multimedia content more efficient and effective through a better distribution of tasks.

The above and other objects are achieved by a system and method that allows the efficient distribution of rich media to clients by maximizing the use of available bandwidth and client processing capabilities. Rich media refers generally to multiple types of digital media that are directly sensed by a viewer, including video, audio, text, graphics, and the combination of these and other media. In accordance with the invention, a rich media presentation is divided into discrete components, and a producer specifies how a presentation is to be assembled and where resources needed for the presentation are to be found. This information is packaged into a data structure and sent to clients. Clients use this data structure to retrieve the necessary resources for the presentation.

This modularization of the presentation provides numerous advantages. For example, producers are able to prioritize the particular resources that form part of the ultimate presentation according to their importance in the presentation. It also allows clients to retrieve the resources most suitable for their capabilities, including processing power, graphics production speed, and bandwidth. A benchmarker routine running on the client helps identify these capabilities just before retrieval of the presentation components, to more closely assess the conditions under which the client will retrieve, assemble and present the desired show.

In preferred embodiments, the client device works in a highly autonomous manner, thereby allowing the server to use multicast techniques to distribute data to many clients simultaneously. This autonomy allows each client the ability to display received rich media in the most effective way allowed by each individual client's hardware profile.

Some of the objects of the present invention are method for preparing a multimedia presentation for transmission to a client over a network. The method involves allowing a producer of the presentation to identify elements of software which process data representing resources used in the presentation, specify connections between two or more elements, wherein a connection represents a flow of data from one element to another element, and specify a plurality of resources to be processed by the identified elements and location data indicating the locations of the resources on one or more servers connectable to the network. The method further involves generating a set of presentation data structures, including the identified elements, connections, and resources, for transmission to a client. This enables the client to reproduce the multimedia presentation from the presentation data structures by retrieving at least some of the resources and processing the retrieved resources with the identified elements in accordance with the specified connections.

The set of presentation data structures may include a show graph representing a plurality of identified elements and the connections extending therebetween. The presentation data structures may also include a table of contents listing all or some of the specified resources and corresponding locations. The producer may also be able to replace or swap a first identified element with a second element while retaining for the second element any connection and resources associated with the first element.

As another advantage of the present invention, producers may further specify an encoder to tap a signal on a selected connection and encode the data flowing at the selected connection. The producer may associate the specified encoder with a given set of client processing capabilities or available bandwidth for transmission to a client. Thus, if the server receives data indicating the processing capabilities of a client requesting the presentation or available bandwidth for transmission of the presentation to the client, such as from a benchmarking program running on the client, an agent on the server can traverse a series of identified elements via their connections until a tapped encoder is located being associated with the client's processing capabilities or available bandwidth.

The data flowing at the tapped connection, e.g., the data output from the element at the start of the connection, is then encoded using the specified encoder, and made available for transmission to the client. When the client receives the presentation data structures, it executes an agent which traverses the series of identified elements via their connections until a tapped decoder is located being associated with the client's processing capabilities or available bandwidth. The agent initiates this decoder to decode the data at the tapped connection.

Objects of the present invention are also achieved by a system for delivering a multimedia presentation from a server to a client. The system contains a presentation authoring tool for use by a producer of the presentation to identify software elements for processing data representing resources used in the presentation, specify connections between two or more elements representing a flow of data from one element to another element, specify a plurality of resources to be processed by the identified elements and location data indicating the locations of the resources on one or more servers connectable to the network, and specify an encoder to tap a signal on a selected connection and encode the data flowing at the selected connection. The system also contains an agent for traversing a series of identified elements via their connections until a tapped encoder is located and encoding the data at the tapped connection using the specified encoder.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting data flow and distribution according to one embodiment of the present invention;

FIG. 2 is a block diagram presenting the distribution of data packets upon receipt by a client device, according to one embodiment of the present invention;

FIG. 3 is a block diagram presenting the configuration of various hardware and software components according to one embodiment of the present invention;

FIG. 4 is a block diagram presenting the layout of software elements within the Show Graph Authoring Tool according to one embodiment of the present invention;

FIG. 5 is a block diagram presenting the interconnection of software elements within the Show Graph Authoring Tool according to one embodiment of the present invention;

FIG. 6 is a flow diagram presenting the distribution and utilization of the Show Graph according to one embodiment of the present invention;

FIG. 7 is a block diagram presenting the inclusion of a low bandwidth tap within a Show Graph, displayed by the Show Graph Authoring Tool, according to one embodiment of the present invention;

FIG. 8 is a block diagram presenting the inclusion of a high bandwidth tap within a Show Graph, displayed by the Show Graph Authoring Tool, according to one embodiment of the present invention;

FIG. 9 is a block diagram presenting the inclusion of both low and high bandwidth taps within a Show Graph, displayed by the Show Graph Authoring Tool, according to one embodiment of the present invention;

FIG. 10 is a flow diagram presenting the distribution and utilization of a Show Graph that includes taps, according to one embodiment of the present invention; and

FIG. 11 is a flow diagram presenting the process of client benchmarking according to one embodiment of the present invention.

### DETAILED DESCRIPTION OF THE PREFERRED EMBODIMENTS

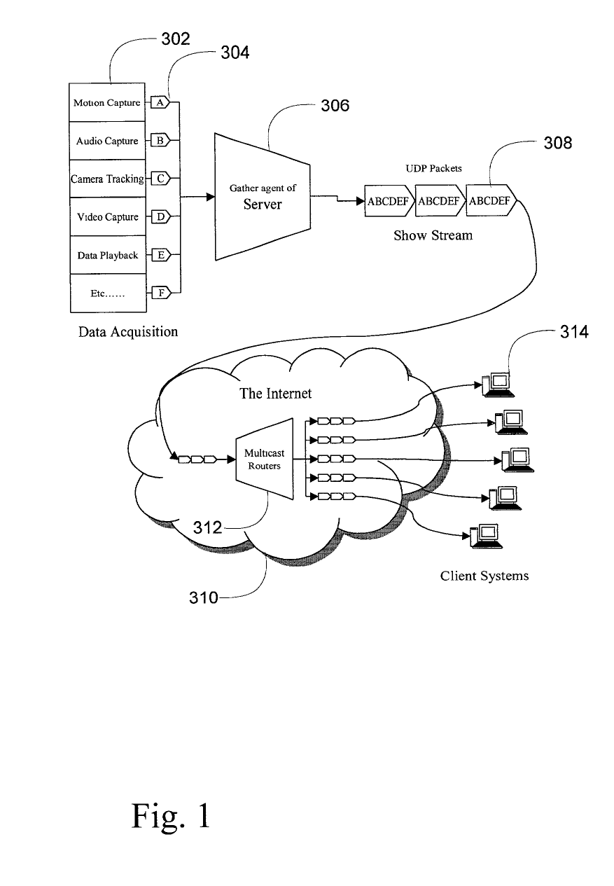

Embodiments of the present invention are now described with reference to the drawings in FIGS. 1-11. FIG. 1 presents a conceptual overview of embodiments of the invention involving creation, synchronization and distribution of a data stream to clients across a computer network. The data for a rich media presentation or show is acquired from various sources 302. The presentation data is comprised of a number of media types presented in an integrated fashion. Exemplary media types include, but are not limited to, motion data, camera position data, audio data, texture map data, polygon data, etc. Components of the system described more fully below generate data packets 304 for each media type and load or transferred them to a server computer 306. Each packet of data is synchronized with one or more other packets to display a coherent presentation. For example, a plurality of video frames comprises motion data, audio data and text data. Each packet of data contains information regarding a particular type of media for a specific frame of the video. If the packets are not synchronized, the audio and visual portions of the video will not be presented in their intended order, rendering the receiving device unable to present a coherent scene to the viewer. The server 306 receives the data packets and assembles them into a data stream 308.

The data stream 308 is distributed to clients 314 across a computer network 310. According to one embodiment, the data is transmitted to a specific port on a multicast router 312 residing on the Internet, an intranet or other closed or organizational network 310. Multicast routers execute multicast daemon software (not shown) that accepts subscriptions from clients that wish to receive multicast data sent to the port subscribed to. When the multicast router receives data packets 304, such as the data packets contained in a data stream 308, each packet is duplicated and transmitted simultaneously to all subscribing clients 314. This methodology allows multiple clients 314 to receive a desired data stream 308 without requiring the server 306 to maintain and manage a connection with each individual client.

As described more fully below, the breakdown of the show into discrete components allows for a number of enhancements to reduce bandwidth, increase efficiency, and improve the ultimate quality of the show on the client computers. Different renderers process the different media types. Producers adjust settings within the show. Clients use renderers differently in accordance with client processing capabilities or available bandwidth.

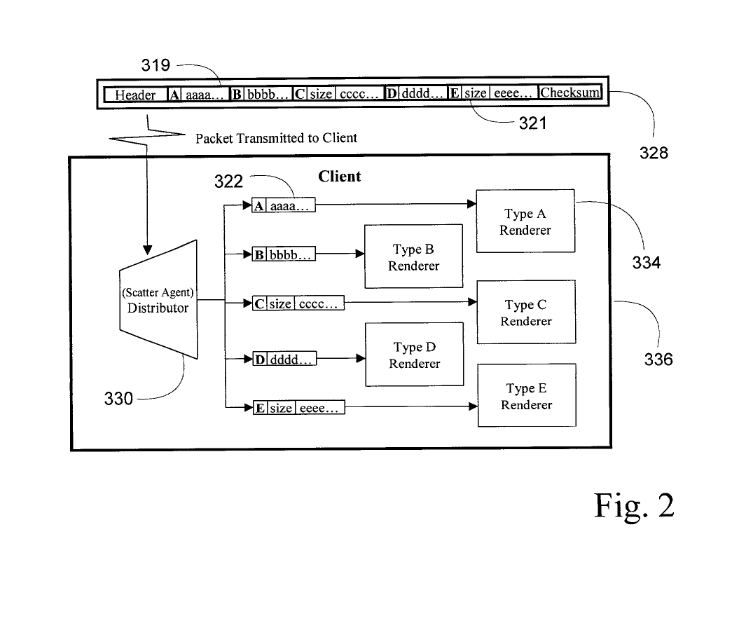

FIG. 2 illustrates how, in presenting a show, the client breaks up packets from the server. The client 336 receives a data stream 328 comprised of a number of coordinated media packets 319 and 321. A distributor 330 parses the data stream and decomposes it back into its constituent packets 322. The distributor 330 may be embodied in hardware and software, or may be implemented as a software program executing on the client. The client stores or has access to a number of renderers 334. Each renderer 334 is configured to accept packets 322 of a particular media type and convert it into information that may be experienced by the viewer. Each packet 322 is rendered by its associated renderer 334 and presented to the viewer. For example, an audio renderer takes packets of audio data and generates sound information heard by the listener while a video renderer accepts packets of video data and presents it to the viewer on a display device.

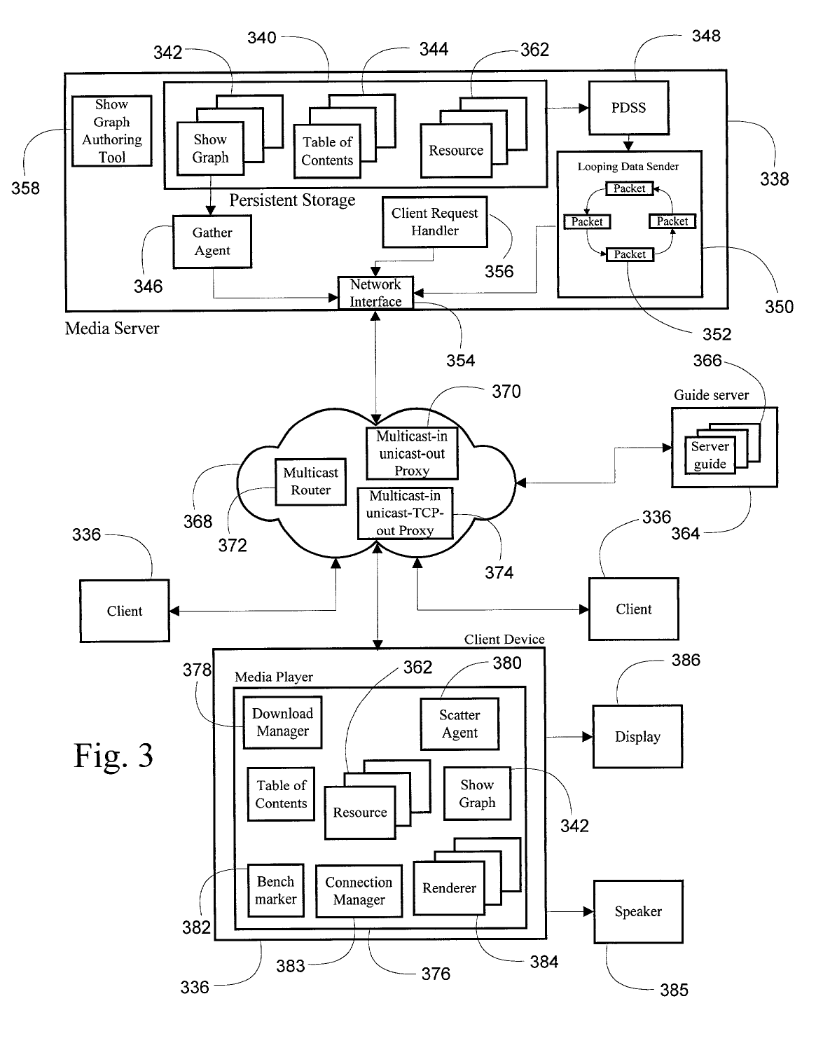

Referring to FIG. 3, a system of one preferred embodiment of the invention is presented. A number of clients 336 and servers 338 and 364 are connectable to a network 368 by various means. For example, if the network 368 is the Internet, the servers 338 and 364 may be web servers that receive requests for data from clients 336 via HTTP, retrieve the requested data, and deliver them to the client 336 over the network 368. The transfer may be through TCP or UDP, and data transmitted from the server may be unicast to requesting clients or multicast to multiple clients at once through a multicast router.

In accordance with the invention, the Media Server 338 contains several components or systems including a Show Graph Authoring Tool 358, a Gather Agent 346, a Packetized Data Source Structure 348, a Looping Data Sender 350, and a Client Request Handler 356. The Media Server 338 further contains persistent storage 340, such as a fixed hard disk drive, to store data including show graphs 342, tables of contents 344, and show resources 362. These components and data may be comprised of hardware and software elements, or may be implemented as software programs residing and executing on a general purpose computer and which cause the computer to perform the functions described in greater detail below.

The Packetized Data Source Structure 348 is provided to retrieve data from any number of data sources, such as a persistent storage device 340. The Packetized Data Source Structure 348 takes a contiguous segment of data as input and produces a plurality of discrete data packets 352. Each data packet 352 is tagged with identifying information including the packet's position or number in the overall sequence of packets, the total number of packets that comprise the contiguous portion of data that is to be sent to the client, and the number of bytes contained within the packet. The packets 352 may be tagged with additional information required by a given communications protocol, hardware device, or software application requesting the data on the client device.

One or more Looping Data Senders 350 receive packets 352 generated by the Packetized Data Source Structure 348. The Looping Data Sender 350 takes each packet 352 and transmits it by way of an integrated or external network interface 354 to clients 336 via a network 368. After the final packet 352 in the sequence is received and transmitted, the Looping Data Sender 350 begins re-transmitting the packets starting with the first packet in the sequence. In this manner, the Looping Data Sender continually “loops” through the transmission of the packets, allowing clients 336 to receive all packets regardless of the point in the transmission sequence at which they began receiving packets. This allows clients 336 to receive any dropped or otherwise missing packets without having to interrupt the server 338 and 364 or waste bandwidth transmitting requests for retransmission.

The operation of the Packetized Data Source Structure and Looping Data Senders are described in greater detail in commonly owned patent application Ser. No.______ filed on even date herewith and titled “SYSTEM AND METHOD FOR RECEIVING PACKET DATA MULTICAST IN SEQUENTIAL LOOPING FASHION,” which has been incorporated herein by reference. Among other things, the use of this delivery mechanism in the show distribution system described herein enlarges the number of connections that can be made to receive a show at any one time.

The server 338 or 364 transmits packetized data via the network 368 to any client 336 requesting the data. The client is equipped with an integrated or external network adapter used to receive data packets from the network 368. The client has persistent and transient memory for storing received data packets, storing and executing application programs, and storing other resources. One application stored in persistent memory and executed in transient memory by the client is a Media Player 376, which is used for the playback of multiple types of media including, but not limited to, audio, video, and interactive content.

The Media Player 376 contains several components or systems including a Download Manager 378, a Scatter Agent 380, a Benchmarker 382, a Connection Manager 383, and one or more Renderers 384. In alternative embodiments, these components are standalone software or hardware components accessed by executing applications, such as the Media Player 376.

The Media Player 376 issues requests for media packets 352 to a server 338 or 364. If the server 338 or 364 is multicasting the content, the client request takes the form of a subscription to the router 372. Packets are received across the network 368 via the client's network interface adapter. The Media Player 376 or other application requesting data from the server accepts and records receipt of packets in memory. Upon receipt of a duplicate packet, the client will stop receiving further packets, as the receipt of a duplicate packet is an indication that the packet sequence has looped around to the point at which the client first starting receiving packets and therefore the client should have received al the packets in the sequence. The client checks whether any packets in the sequence are missing and, if so, determines if the time to wait for the Looping Data Sender 350 to retransmit the packet is greater than a time threshold, such as the time needed to directly request and receive the missing packet or packets from the server, or a predefined threshold set by the content producer. If the time to wait for the packet to be received is greater than the threshold, the Download Manager 378 issues a request to the Client Request Handler 356. Upon receiving the request, the Client Request Handler 356 accesses the Looping Data Sender 350, duplicates the requested packet and transmits it to the client 336. The result is that clients are continually fed a stream of requested data and can recover missing packets by either simply awaiting retransmission of the packet or requesting it directly, whichever the client deems is most efficient given the bandwidth constraints of the client.

Client device 336 contains and executes a Connection Manager 383 in order to negotiate and maintain a connection with Media Servers 338. The Connection Manager 383 executes routines on the client 336 when an attempt is made to establish the connection. As explained more fully below, the routines include directing the client 336 to establish a multicast, multicast-to-unicast, or unicast TCP connection based upon the requirements of the network provider that the client device 336 is using to connect to the data network 368. The connection manager software 383 further determines appropriate bandwidth and ensures that resources are being received appropriately.

When a client 336 requests the transmission of content, a connection is first established with a Guide Server 364. The Guide Server 364 parses the client request and returns an appropriate Server Guide 366 based on the request. The Server Guide 366 comprises a listing of all Media Servers 338 connected to the network 368 that are capable of transmitting the content requested by the client 336 via its Connection Manager 383. The client 336 receives the Server Guide 366 and attempts to initiate a connection with the first Media Server entry in the guide 366.

The Connection Manager 383 opens a connection between a Media Server 338 and the client 336 based on the server address listed in the Server Guide 366. The client 336 attempts to make a connection with the Media Server 338 using the servers listed in the Server Guide 366, as described more fully in commonly owned patent application Ser. No.______, filed on even date herewith and titled “SYSTEM AND METHOD FOR MANAGING CONNECTIONS TO SERVERS DELIVERING MULTIMEDIA CONTENT,” which has been incorporated herein by reference.

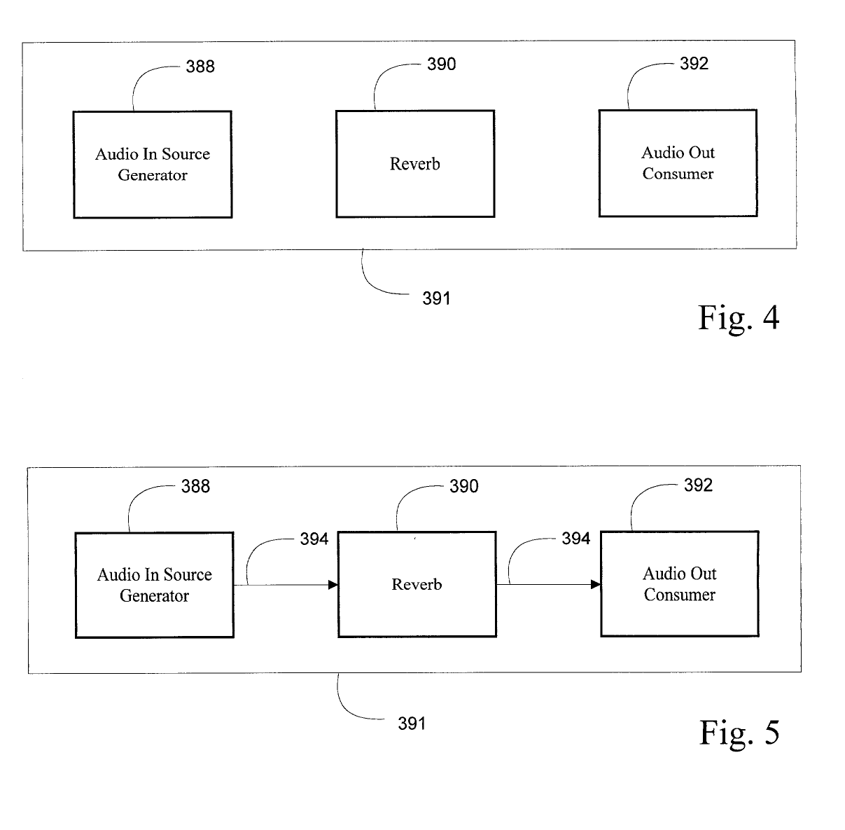

Producers of multimedia content use the Show Graph Authoring Tool 358 to arrange representations of software elements and their interconnections. The Show Graph Authoring Tool 358 is a standalone software application employing a graphical user interface (GUI) that allows the producer to visually configure representations of software elements that act on data. Each grouping of elements is referred to as a scene and may exist as a subset of other scenes collectively referred to as a Show Graph 342 or simply a Show. FIG. 4 presents one exemplary series of elements arranged using the Show Graph Authoring tool 391. Elements are visually manipulated on the display with the Producer selecting the desired elements. In its most basic form, the show must consist of a “generator” or element that produces data and a “consumer”, the element that manipulates or otherwise acts on the data. This illustration provides as elements an audio-in source generator 388 and an audio-out consumer 392, along with a reverb element 390 that will add a reverb effect to any audio data that it receives.

The Show Graph 342 is an acyclic directed graph, meaning that data moves from one element to the next and will not cycle back from where it came in the graph. Elements comprising a Show Graph 342 are interconnected by signals 394 (FIG. 5) representing pathways that direct data from one element to the next. The elements and their interconnections determine how data is processed and presented to the viewer by the client 336. FIG. 5 builds on the illustration presented in FIG. 4 by illustrating interconnections made by the producer from the audio-in source generator 388 to the reverb 390 and on to the audio-out consumer 392 elements. This show graph 342 provides instructions for the generation of audio, the passing of the resultant data to a reverb element for the addition of reverb, and the sending of the modified audio data to an audio-out for presentation to the viewer.

The Show Graph Authoring Tool 358 retrieves data indicating the current use of resources for a specific client bandwidth, graphics, and CPU capacity. Bandwidth may be measured as the time it takes a client to download a given piece of data. Graphics capacity may be measured as the number of triangles a client can draw to a display device per second. CPU power may be measured as the number of vertices a system can transform per second. With these measurements, the producer derives a “minimum show setting” at or above which the client must function to properly display the show. The producer then defines varying levels at which the show is rendered to provide for both clients with limited and superior bandwidth and CPU capacity. Bandwidth is determined when the taps are laid into the graph.

The Show Graph Authoring Tool 358 further provides the Producer with flexibility as to how to view a scene. The producer can view a show along an animated timeline that sets the elements in order of their timing in the show. Alternatively, the producer can view the show graph as a two dimensional representation of one possible client configuration, or view multiple configurations simultaneously. Client configurations and the arrangement of elements within a show graph can be freely modified in any mode. Elements and resources in show graphs are identified by globally unique identifiers to support their interchangeability on a system-wide basis. Show graphs 342 are generated and stored on a persistent storage or other type of memory device for transmission to clients 336 requesting a show.

The Show Graph 342 organizes the software components that manipulate Resource data to present a show to a viewer. Resources include, but are not limited to, data such as models used by the Renderers 384, texture maps used by these models, motion data, and audio data.

Client systems vary widely in terms of their computational and graphics power. When a producer generates a Show Graph 342, multiple sets of resources are also created to support show requiring varying amounts of bandwidth and processor power. By creating multiple versions of the same Resources 362 at varying quality levels, the Producer is given the ability to deliver his or her story across a wide spectrum of client systems 336 while maximizing the quality of the presentation of the story. As will be explained herein, the client 336 selects the Resource or Resources that will present the highest quality show given the limitations of the client 336. For example, suppose a Producer generates three 3D models of an actor, one at a resolution of 1000 triangles, another at a resolution of 10,000 triangles and a third at a resolution of 20,000 triangles. Alternatively, Resource resolution is measured in pixels or any other suitable measurement for assessing the resolution of an image. A Client selects the model that will produce the best show possible based upon its specific hardware and bandwidth constraints.

The Media Server 338 also stores and delivers a Table of Contents 344 along with the Show Graph 342 to requesting clients 336. The Table of Contents 344 is a listing of various versions of the Resources 362 required by a Show 342 and the channels on which those Resources are found. As explained above, a channel is an abstraction encompassing a Server 338 or 364 address and a port number where the associated Resource 362 can be found. Each Resource 362 is listed in the Table of Contents 344 in the order of importance of the Resource. The importance of each Resource 362 is equal to the relative value that each Resource has in the delivery of the Show Graph 342. For example, if the story presented to the viewer concerns a news anchor delivering the daily headlines, a high polygon count version of the anchor is more important than a high polygon count of the anchor's desk. Thus, the listing for the high polygon count version of the anchor would appear in the Table of Contents before a high polygon count version of the desk.

Providing pointers or links to a plurality of identical Resources of varying resolutions or detail allows the system to provide for potentially unlimited scalability. The client 336 determines its capabilities, and therefore the Resources it will retrieve to present a show, through the user of a Benchmarker 382. The Benchmarker measures the client's CPU and graphics power. In one embodiment the Benchmarker 382 collects data regarding CPU time and graphics fill rate. CPU time is defined as the amount of time the CPU spends processing the transformation of vertices in a 3D Renderer 384. The graphics fill rate is a measurement of how much time the 3D Renderer 384 takes to fill triangles and load texture maps. The Renderer 384 calculates execution time by examining a system clock (not pictured), typically part of a general purpose computer's standard hardware.

The Benchmarker 382 performs these calculations several times in succession to derive a weighted average. Averaging helps prevent spurious changes in the data from creating spurious changes in the quality of the Show. It is also used to compensate for irregularities encountered in multithreaded systems. In multithreaded systems, multiple processes are run simultaneously by swapping out each process in a sequential manner. “Swapping out” is a method whereby the state of the processor and the memory used by a process are moved to a section of memory for temporary storage. The processor swaps in the processor state and memory of the next process and runs that process for some predetermined amount of time. This process is repeatedly executed, giving the impression to the user that all processes are running simultaneously.

One side effect of this process is that measurements of the amount of time a process takes using a real world clock may be different than the actual amount of CPU time the process needs. Averaging minimizes these inconsistencies and allows a more accurate appraisal of the capabilities of a client 336. Based on the results of these calculations and Producer set parameters, the client 336 dynamically determines the Resources 362 that provide the best possible viewing experience based on the limitations of the client device 336.

The client 336 contains one or more Renderers or Rendering Engines 384 that receive Resource data 362 and convert it into information the viewer experiences. For example, an audio renderer receives audio resources and produces sound data as output to a speaker 385 integrated or externally connected to the client 336. Likewise, a character generation renderer takes a stream of text data as input and generates a line or lines of text on a display device 386 integrated or externally connected to the client 336.

As described above, Resources 362 exist at varying levels of complexity. Renderers 384 determine which Resources 362 will be selected from a Table of Contents 344 for a particular show and presented to the viewer. The Benchmarker 382 gives each Renderer 384 the results of its calculations. Based on the calculations, the Renderer 384 modifies the versions of the Resources 362 it selects to conform to these measurements. For example, if a 3D Renderer determines that it can use significantly more CPU time than is currently being used based on the Benchmarker's calculations, it automatically refers to the Table of Contents and selects Resources of a higher resolution. Similarly, if the 3D Renderer has a significantly greater fill rate capacity than is currently being used, more complex and detailed texture map Resources will be located in the Table of Contents and retrieved from the appropriate server.

In preferred embodiments, Media Servers 338 transmit a Show Graph or Graphs 342 to a multicast router 372 for distribution to subscribing clients 366. A Gather Agent 346 analyzes a Show Graph 342 before it is transmitted to requesting clients 336. The Gather Agent 346, and its associated Scatter Agent 380 described in greater detail below, is designed to carry data in a variable capacity buffer and tasked to traverse a Show Graph 342 and do work on the elements therein. When an agent arrives at an element on the Show Graph 342, the number of bytes contained within the element is determined and the Agent expands its buffer to accommodate the data. The agent further issue process calls to each element it analyzes whereby transformation is performed on the data at the element. The process calls manage data coming into and travelling out of an element.

Agents 346 and 380 analyze a Show Graph 342 by traversing all elements contained therein, starting at the Show Node or top level node connecting all other elements in the graph. The Agent 346 and 380 traverses the Show Graph 342 from each Signal 394 destination to its source, seeking a node containing no incoming signal. This type of element is referred to as a “generator” and typically produces digitally encodable input. When a generator is arrived at, the Agent traverses the Show Graph in the reverse direction towards the Show Node. The data collected by the agent is then either delivered to a client or passed to a renderer for presentation to a viewer, depending on whether the agent is a Gather Agent 346 or a Scatter Agent 380.

In accordance with preferred embodiments of the invention, the Gather Agent 346 is a server generated software component. The Gather Agent 346 traverses the Show Graph 342 until a generator is reached. Data is collected from the generator and placed in the Gather Agent 346 buffer. The Gather Agent 346 moves from element to element, following the path between elements defined by the interconnecting signals, and processes the data at each element. In situations where there are multiple paths leading to a Show Node, the Gather Agent 346 traverses each of these child paths. Upon completing traversal of all paths, the Gather Agent 346 has collected all data for the show in its buffer. The buffer is delivered to the client 336 using an operating system specific call. For UNIX and Win32 operating systems, this call is named “sendto”. The sendto call takes three parameters: the data buffer, the destination IP address, and a port number on the destination machine.

A Scatter Agent 380 receives a Gather Agent's 346 data buffer on this other side of a communication connection. Data is received on the client using an operating specific call referred to as “receivefrom”, which is analogous to the “sendto” command executed on the transmitting machine. The Scatter Agent 380 traverses the Show Graph 342 delivered to the client 336 from a Media Server 338 until the appropriate generator is found. The Agent 380 reverses direction when the appropriate generator is found and moves along Signals 394 from element to element and executes process calls at each element in the path. The Agent 380 arrives at the Show Node where the data in the Agent 380 buffer is acted upon by Renderers 384 for presentation to a viewer.

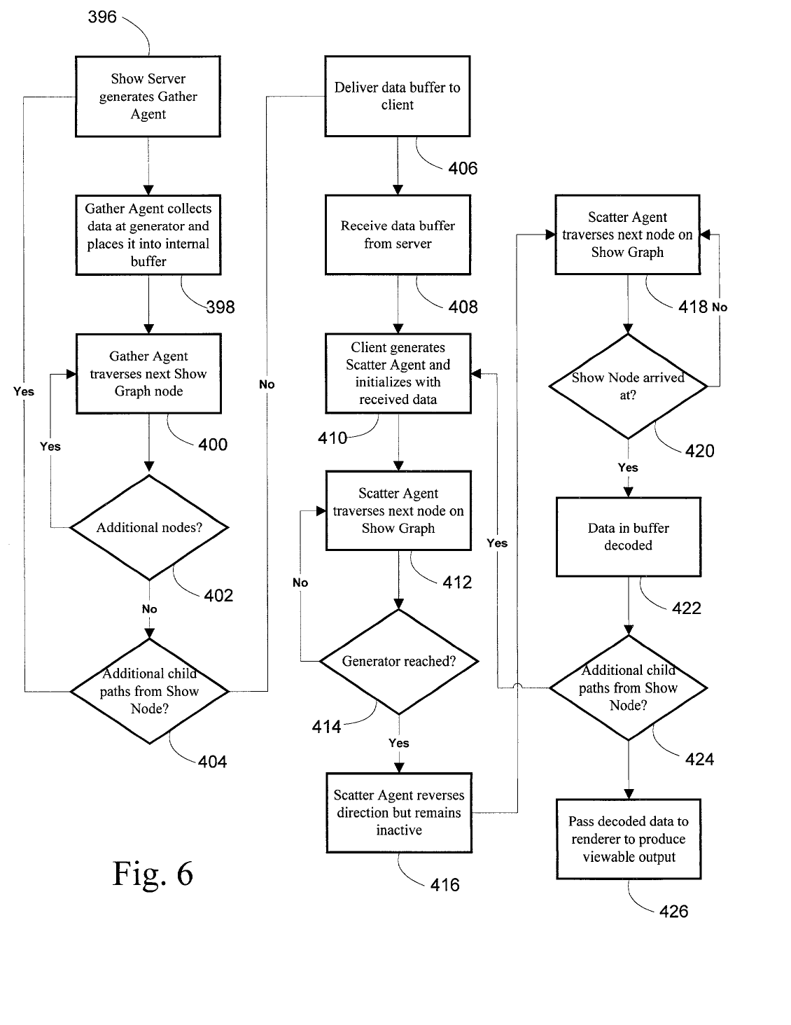

One embodiment of a process using the system of FIG. 1-5 is shown in FIG. 6. A Media Server generates a Gather Agent in response to a request from a client for a Show, step 396. The Gather Agent identifies the requested Show Graph and begins to traverse the interconnected elements until an element is arrived at with no signal leading into it, e.g., a generator element, step 398. The Gather Agent reverses direction, following Signals from the generator to the next element in the signal path, step 400. If additional nodes are present, step 402, the Gather Agent traverses these elements, step 400, until a Show Node is found indicating no subsequent elements lie along the current signal path. Where additional child paths from the Show Node are present on the Show Graph, step 404, the Gather Agent follows each signal path to its generator and repeats the process of steps 396 through 400.

Once all child paths have been traversed, the Gather Agent's data buffer is delivered to the client, step 406. Upon receipt of the data buffer from the server, step 408, the client generates a Scatter Agent initialized with the received data, step 410. Starting at the Show Node, the Scatter Agent traverses the next element on the Show Graph but remains inactive, step 412. The Scatter Agent continues to traverse elements, following signal paths contained in the Show Graph, until a generator is reached, steps 412 and 414. Upon arriving at a generator, the Scatter Agent reverses direction, step 416. The Scatter Agent traverses the subsequent element of the show graph and decodes the data in its buffer intended for the current element by issuing a process call, steps 418 and 420. If the next element is not a Show Node, step 422, the decoding process is repeated, steps 418 and 420. Once the Show Node is arrived at, a check is preformed by the Agent to determine if additional child paths lead from the Show Node to additional generators, step 424. Where additional child paths exist, the process is repeated, steps 412 through 422, to properly decode all data contained within the Scatter Agent. Once all paths have been traversed, the decoded data is passed to the appropriate Renderers to produce output to the viewer, step 426.

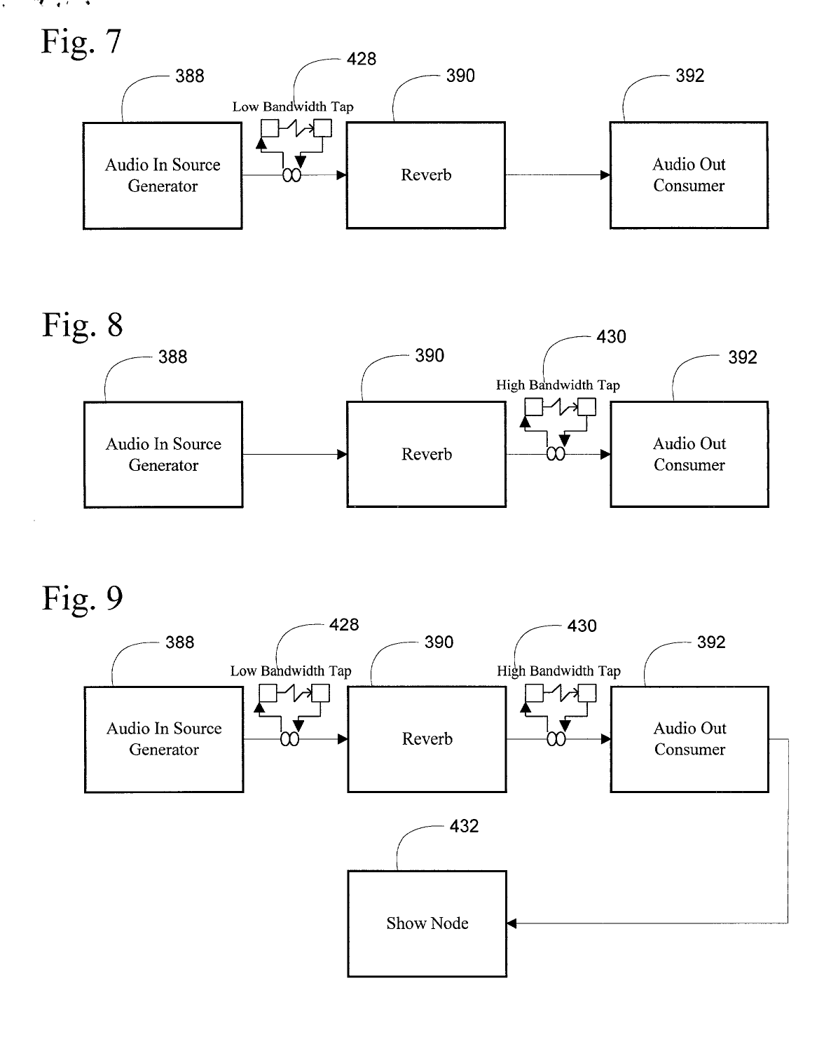

FIGS. 7-9 present alternative embodiments of the invention whereby a Producer uses the Show Graph Authoring Tool 391 to place Taps 428 and 430 along Signals 394 within a Show Graph that will encode or decode data and allow a Producer to manage the bandwidth of a connection. A Tap 428 and 430 is designed for specific bandwidths. Based on the bandwidth design specified by the Tap, a specific type of encoding is performed. For example, a Tap that needs to satisfy a 28 Kb/sec bandwidth connection would use a compressor that has a high enough compression ratio so that data encoded at the Tap fits into a 28 Kb/sec transmission. Placement of Taps controls which functions within the Show Graph the server handles and which the client handles, thereby establishing a dynamic load balancing. Taps also allow for the use of third party software, such as encryption, and for the development of additional modular programs by third parties which may be more easily brought into a show's development and delivery.

Elements are arranged within the Show Graph Authoring Tool. The Producer places Taps within the Show Graph to determine the most advantageous point to analyze and transmit the data, creating Shows of different quality for clients with different capabilities. FIG. 7 presents a Show Graph containing a low bandwidth tap 428. The Producer looks for points in the Show graph where the data can be encoded and sent to the Client in a form as close to the original as possible. The Producer reviews the Show with the client machine's capabilities, making judgments regarding acceptable quality. Specific encoding or compression is performed based on the bandwidth design specified by the particular Tap.

The low bandwidth Tap 428 presented in FIG. 7 is placed between the audio in generator 388 and the reverb filter 390. This is the point where the data is voice data and is most easily compressed. The Tap at a low bandwidth encodes data generated by the audio in source 388, e.g., 2.4 Kb/sec, that sounds comparable to the audio produced by a cellular telephone. The Producer sets all Taps in the Show Graph. The taps are set so the sum of bandwidth in all the low bandwidth taps is less than the upper limit on the number of bits that can be reliably received over the client connection.

FIG. 8 presents an alternative embodiment of the Show Graph. Here, a high bandwidth Tap 430 is placed between the reverb filter 390 and the audio out consumer 392. A different high bandwidth Tap 430, such as one based on the mp3 codec, is used. In this illustration, the high bandwidth Tap 430 is placed after the reverb filter 390 so better use can be made of the higher bandwidth. FIG. 9 shows the two Show Graphs presented in FIGS. 7 and 8 merged into one Show Graph representing both scenarios. Because the Taps have been defined by specific bandwidth, only clients within their defined bandwidth range act on them.

Placement of Taps 428 and 430 before and after the reverb filter 390 is significant. Filtering involves altering the quality of the data by manipulating input data and transforming it to a different form. By placing the Tap 428 before a filter in the low bandwidth scenario, the data is passed to the client encoded at a low bandwidth without first being reverberated. The encoding entails a sacrifice of quality since the encoder at a low bandwidth will not yield the best sound fidelity. The client receives the data and decodes it using a low bandwidth Tap. The client, through the use of its Scatter Agent, passes the data through a Renderer without assistance from the server since the client is also running a copy of the Show Graph. Decoding on the client side saves crucial bandwidth in transmission and utilizes the computational ability of the client, balancing the processing load between client and server. Conversely, in the high bandwidth Tap scenario the Tap is placed after the reverb filer, allowing the server to perform the reverb conversion and encode the resultant data according to any number of high bandwidth compression methods. The client decodes a voice with reverb at a high sound fidelity, but at the price of high bandwidth consumption. Finally, the use of multiple taps in this fashion allows a client to dynamically modify its bandwidth and show quality by referencing the appropriate data without active participation by the server.

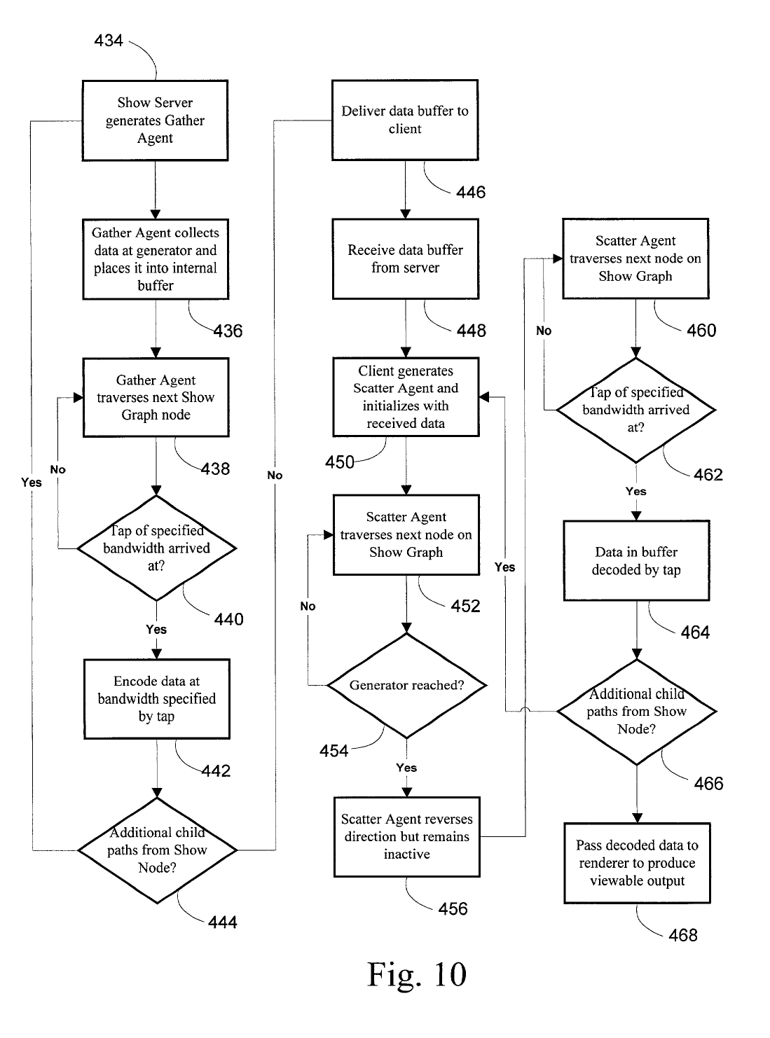

One embodiment of a process using the system of FIGS. 1-5 and 7-9 is shown in FIG. 10 whereby Taps are placed within a Show Graph and acted upon appropriately by Gather and Scatter Agents. In response to data requested by a client, the server retrieves the requested Show Graph and generates a Gather Agent, step 434. The Gather Agent traverses the Show Graph until arriving at an element without a signal leading into it, e.g., a generator element, and places the data from the element into its buffer, step 436. The Gather Agent traverses subsequent elements comprising the Show graph, step 438, until arriving at a Tap of specified bandwidth, step 440. Each Agent is designed to analyze Taps that have a specific bandwidth. For example, a low bandwidth Agent is designed to analyze a tap encoding and decoding at 22 Kb/sec. This agent would not analyze data at a tap encoding and decoding at 56 Kb/sec.

Once the Agent arrives at the specified Tap, data contained within its buffer is encoded, the Agent deactivates, and traverses the Show Graph until arriving at the Show Node, step 442. A check is performed to determine if additional child paths radiate from the Show Node. Where additional child paths are present, step 444, the process of steps 436 through 442 is performed on each path.

The encoded data buffer is transmitted from the server, step 446, and received by requesting clients, step 448. The client generates a Scatter Agent and initializes it with the received data buffer, step 450. Starting at the Show Node, the Scatter Agent traverses each element in the Show Graph, step 452, until it reaches a generator element, step 454. The Agent reverses direction when it arrives at a generator, but remains inactive, step 456.. The Agent moves away from the generator toward the Show Node, step 460, until it arrives at a Tap where data is delivered to the signal data buffer and decoded, step 462. For example, a client utilizing a low bandwidth Scatter Agent only activates at low bandwidth Taps.

Data in the Scatter Agent's buffer is decoded by the Tap, step 464, after which the Agent processes the decoded data and proceeds along the Show graph executing process calls at each element encountered between the Tap and the Show Node. When the Scatter Agent arrives at the Show Node, a check is made to determine if additional child signal paths radiate from the Show Node, step 466. If additional child paths are present, the Scatter Agent traverses each child path according to steps 452 through 464. Data contained in the Agent's buffer is decoded and passed to appropriate Renderers to produce output to the viewer, step 468.

Resources 362 are used by the Show Graph 340 to present a show to a viewer. As described above, a Media Server 338 provides a client 336 with both a Show Graph 340 and its associated Table of Contents 344. The client 336, using its benchmarker routine 382, determines the current processing power of the client. These metrics are used as parameters by the Renderers 384 to determine the highest quality Resources 362 listed in the Table of Contents that the client 336 is capable of presenting to the viewer. The client 336 also reads the Table of Contents 344 and examines its own memory to determine which resources of the show are already resident on the client 336.

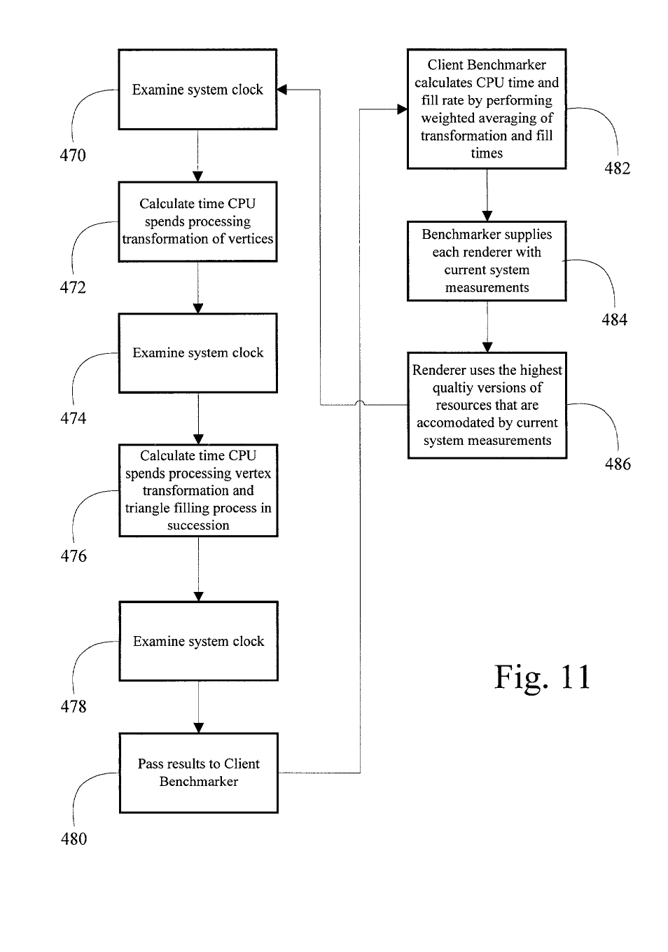

FIG. 11 presents one embodiment of a process utilizing the system for calculating a client's benchmark metrics and using the calculated data to render the most detailed resources possible. The Benchmarker examines the system clock, step 470. The Benchmarker performs a vertex transformation using a 3D Renderer, step 472. When the vertex transformation is complete, the system clock is again examined to determine how long the transformation took, step 474. This clock measurement is also used to begin timing of a graphics fill rate test whereby the 3D Renderer performs a graphics fill on a set of triangles and loads a series of texture maps, step 476. The system clock is again examined to determine the length of time taken by the calculation, step 478. The Benchmarker receives the results from the 3D Renderer, step 480.

The Benchmarker calculates final CPU processing and graphics fill time by performing a weighted averaging of transformation and fill times, step 482. Averaging allows the Benchmarker to prevent spurious changes in this data from creating spurious changes in the quality of the show presented to the viewer, especially in multithreaded systems. The Benchmarker supplies each Renderer with the current system measurements, step 484, so each may independently determine the proper Resources to utilize given current client performance. Each Renderer receives the benchmark data and, by analyzing the listing of Resources contained in the Table of Contents, retrieves the highest quality versions of Resources capable of currently being supported by the client, step 486. The process is repeated starting at step 470 as client performance is in a constant state of flux.

While the invention has been described and illustrated in connection with preferred embodiments, many variations and modifications as will be evident to those skilled in this art may be made without departing from the spirit and scope of the invention, and the invention is thus not limited to the precise details of methodology or construction set forth above as such variations and modifications are intended to be included within the scope of the invention.

What is claimed is:

1. A method implemented by a client computer for retrieving a multimedia presentation from a server over a network and presenting the presentation, the method comprising:
performing one or more benchmarking tests on the client computer to determine one or more operational parameters of the client computer;
retrieving a presentation data structure from the server identifying a plurality of software elements and data resources used in reproducing the presentation, the software elements and resources being associated with varying types of operational parameters;
selecting a subset of the elements and resources based upon the client's operational parameters determined in the benchmarking tests; and
retrieving the selected elements and resources to thereby reproduce the presentation.

2. The method of claim 1, wherein performing one or more benchmarking tests comprises testing the client computer's CPU speed.

3. The method of claim 2, wherein testing CPU speed comprises measuring time spent by the CPU processing transformations of vertices in a three-dimensional renderer.

4. The method of claim 1, wherein performing one or more benchmarking tests comprises testing the client computer's graphics fill rate.

5. The method of claim 4, wherein testing the graphics fill rate comprises measuring time spent by a three-dimensional renderer running on the client computer in filling triangles.

6. The method of claim 4, wherein testing the graphics fill rate comprises measuring time spent by a three-dimensional renderer running on the client computer in reading texture maps.

7. A computer readable medium storing program code for, when executed, causing a computer to perform a method for retrieving a multimedia presentation from a server over a network and presenting the presentation, the method comprising:
performing one or more benchmarking tests on the client computer to determine one or more operational parameters of the client computer;
retrieving a presentation data structure from the server identifying a plurality of software elements and data resources used in reproducing the presentation, the software elements and resources being associated with varying types of operational parameters;
selecting a subset of the elements and resources based upon the client's operational parameters determined in the benchmarking tests; and
retrieving the selected elements and resources to thereby reproduce the presentation.

8. The medium of claim 7, wherein the step performed by the computer of performing one or more benchmarking tests comprises testing the client computer's CPU speed.

9. The method of claim 8, wherein the step performed by the computer of testing CPU speed comprises measuring time spent by the CPU processing transformations of vertices in a three-dimensional renderer.

10. The method of claim 7, wherein the step performed by the computer of performing one or more benchmarking tests comprises testing the client computer's graphics fill rate.

11. The method of claim 10, wherein the step performed by the computer of testing the graphics fill rate comprises measuring time spent by a three-dimensional renderer running on the client computer in filling triangles.

12. The method of claim 10, wherein the step performed by the computer of testing the graphics fill rate comprises measuring time spent by a three-dimensional renderer running on the client computer in reading texture maps.
